(19) United States
(12) Patent Application Publication
(10) Pub. No.: US 2020/0218254 A1
(43) Pub. Date: Jul. 9, 2020

(54) CONTROL METHOD OF ROBOT

(71) Applicant: LG Electronics Inc., Seoul (KR)

(72) Inventors: Byungkuk Sohn, Seoul (KR); Byungjoon Kim, Seoul (KR)

(73) Assignee: LG Electronics Inc., Seoul (KR)

(21) Appl. No.: 16/731,572

(22) Filed: Dec. 31, 2019

(30) Foreign Application Priority Data
Jan. 3, 2019 (KR) PCT/KR2019/000086

(51) Int. Cl. G05D 1/00; G01C 21/34; G05D 1/02; G06Q 30/06

(52) U.S. Cl. CPC G05D 1/0022; G05D 1/0088; G01C 21/3476; B62B 3/14; G06Q 30/0617; G06Q 30/0631; G05D 2201/0203; G05D 1/0231

(57) ABSTRACT

A method of controlling a robot, including operating in a following travel mode of following a user, operating in a guide mode for providing an escort service of providing guidance to a predetermined destination according to a received detection signal, and switching back to the following travel mode upon detecting specific movement of the user, in the guide mode.

### CROSS REFERENCE TO RELATED APPLICATIONS

This application claims the benefit of PCT International Application No. PCT/KR2019/000086, filed on Jan. 3, 2019, which is hereby expressly incorporated by reference into the present application.

### TECHNICAL FIELD

The present invention relates to a robot and a control method thereof, and more particularly, to a robot and a control method for providing a service by a robot while switching to a mode suitable for a situation.

### BACKGROUND ART

Robots have been developed for industrial use to administrate some parts of factory automation. Recently, the application fields of robots have further expanded, leading to the development of medical robots, aerospace robots, etc. and the manufacture of robots used in general homes for domestic uses. Among such robots, an autonomous mobile robot is referred to as a mobile robot.

With the increase in the use of robots, the demand for robots capable of providing various types of information, entertainment, and services in addition to the repeated performance of simple functions has increased.

Accordingly, robots for use in a home, stores, and public facilities so as to communicate with people are being developed.

In addition, services using a mobile robot that is capable of traveling autonomously have been proposed. For example, the cited reference (Korean Patent Application Publication No. 10-2008-0090150, Published on Oct. 8, 2008) proposes a service robot capable of providing a service based on a current position thereof while moving in a service area, a service system using the service robot, and a method of controlling the service system using the service robot.

However, a robot that provides service while moving for a specific user is not capable of changing an operation mode according to a situation while moving or providing a service.

Accordingly, there is a need for a method of providing a service by a robot while appropriately switching to a mode according to a situation.

### DISCLOSURE

### Technical Problem

It is an object of the present invention to provide a robot and a control method thereof for providing a service in various operation modes.

It is another object of the present invention to provide a robot and a control method thereof for actively switching an operation mode to provide an optimal service while movement or provision of a service.

It is another object of the present invention to provide a robot and a control method thereof for providing a carrying service and a recommendation service related to shopping.

### Technical Solution

In accordance with an aspect of the present invention, the above and other objects can be accomplished by the provision of a robot and a method of controlling the same for automatically switching an operation mode while moving or providing a service and for providing an optimal service.

In accordance with another aspect of the present invention, the above and other objects can be accomplished by the provision of a method of controlling a robot, including operating in a following travel mode of following a user, operating in a guide mode for providing an escort service of providing guidance to a predetermined destination according to a received detection signal, and switching back to the following travel mode upon detecting specific movement of the user, in the guide mode.

In accordance with another aspect of the present invention, the above and other objects can be accomplished by the provision of a method of controlling a robot, including operating in a guiding mode of providing guidance while moving ahead of a user, monitoring movement of the user while traveling in the guide mode, and converting into a following travel mode of following the user upon detecting specific movement of the user.

### Advantageous Effects

According to at least one of the embodiments of the present invention, a service may be provided in various operation modes, thereby improving use convenience.

According to at least one of the embodiments of the present invention, an operation mode may be actively converted while movement or provision of a service and an optimal service may be provided.

In addition, according to at least one of the embodiments of the present invention, carrying and recommendation services related to shopping may be provided.

Various other effects of the present invention will be directly or suggestively disclosed in the following detailed description of the invention.

### DESCRIPTION OF DRAWINGS

FIG. 1 is a diagram illustrating the construction of a robot system according to an embodiment of the present invention.

FIGS. 2A to 2D are reference diagrams illustrating a robot service delivery platform included in the robot system according to the embodiment of the present invention.

FIG. 3 is a reference diagram illustrating learning using data acquired by a robot according to an embodiment of the present invention.

FIGS. 4, 5, and 6A to 6D are diagrams exemplarily illustrating robots according to embodiments of the present invention.

FIG. 7 illustrates an example of a simple internal block diagram of a robot according to an embodiment of the present invention.

FIG. 8 is a flowchart illustrating a method of controlling a robot according to an embodiment of the present invention.

FIGS. 9 to 14 are reference diagrams for explanation of a service provided at a big-box store by a robot according to an embodiment of the present invention.

FIG. 15 is a flowchart illustrating a method of controlling a robot according to an embodiment of the present invention.

### BEST MODE

Reference will now be made in detail to embodiments, examples of which are illustrated in the accompanying drawings. However, the present invention may be embodied in many different forms and should not be construed as being limited to the embodiments set forth herein.

In the following description, with respect to constituent elements used in the following description, the suffixes “module” and “unit” are used or combined with each other only in consideration of ease in the preparation of the specification, and do not have or indicate mutually different meanings. Accordingly, the suffixes “module” and “unit” may be used interchangeably.

It will be understood that although the terms “first,” “second,” etc., may be used herein to describe various components, these components should not be limited by these terms. These terms are only used to distinguish one component from another component.

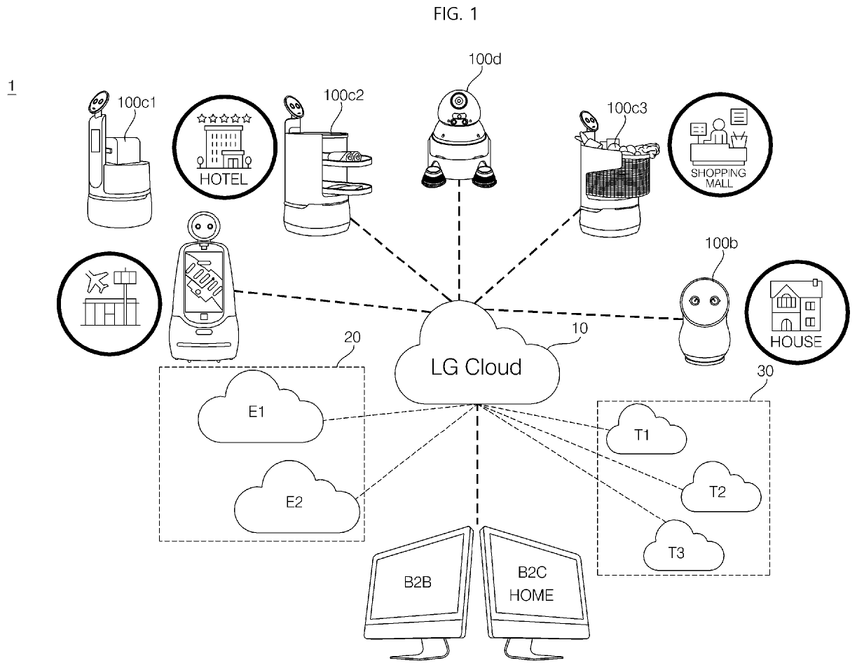

FIG. 1 is a diagram illustrating the configuration of a robot system according to an embodiment of the present invention.

Referring to FIG. 1, the robot system 1 according to an embodiment of the present invention may include one or more robots 100a, 100b, 100c1, 100c2, and 100c3 and may provide services at various places, such as an airport, a hotel, a big-box store, a clothing store, a logistics center, and a hospital. For example, the robot system 1 may include at least one of a guide robot 100a for providing guidance for a specific place, article, and service, a home robot 100b for interacting with a user at home and communicating with another robot or electronic device based on user input, delivery robots 100c1, 100c2, and 100c3 for delivering specific articles, or a cleaning robot 100d for performing cleaning while traveling autonomously.

In detail, the robot system 1 according to an embodiment of the present invention includes a plurality of robots 100a, 100b, 100c1, 100c2, 100c3, and 100d and a server 10 for administrating and controlling the plurality of robots 100a, 100b, 100c1, 100c2, 100c3, and 100d.

The server 10 may remotely monitor and control the state of the plurality of robots 100a, 100b, 100c1, 100c2, 100c3, and 100d, and the robot system 1 may provide more effective services using the plurality of robots 100a, 100b, 100c1, 100c2, 100c3, and 100d.

In more detail, the robot system 1 may include various types of robots 100a, 100b, 100c1, 100c2, 100c3, and 100d. Accordingly, services may be provided through the respective robots, and more various and convenient services may be provided through cooperation between the robots.

The plurality of robots 100a, 100b, 100c1, 100c2, 100c3, and 100d and the server 10 may include a communication element that supports one or more communication protocols and may communicate with each other. In addition, the plurality of robots 100a, 100b, 100c1, 100c2, 100c3, and 100d and the server 10 may communicate with a PC, a mobile terminal, or another external server.

For example, the plurality of robots 100a, 100b, 100c1, 100c2, 100c3, and 100d and the server 10 may communicate with each other using a message queuing telemetry transport (MQTT) scheme.

Alternatively, the plurality of robots 100a, 100b, 100c1, 100c2, 100c3, and 100d and the server 10 may communicate with each other using a hypertext transfer protocol (HTTP) scheme.

In addition, the plurality of robots 100a, 100b, 100c1, 100c2, 100c3, and 100d and the server 10 may communicate with a PC, a mobile terminal, or another external server using the HTTP or MQTT scheme.

Depending on the cases, the plurality of robots 100a, 100b, 100c1, 100c2, 100c3, and 100d and the server 10 may support two or more communication protocols, and may use the optimal communication protocol depending on the type of communication data or the type of a device participating in communication.

The server 10 may be embodied as a cloud server, whereby a user may use data stored in the server 10 and a function or service provided by the server 10 using any of various devices, such as a PC or a mobile terminal, which is connected to the server 10. The cloud server 10 may be operatively connected to the robots 100a, 100b, 100c1, 100c2, 100c3, and 100d and may monitor and control the robots 100a, 100b, 100c1, 100c2, 100c3, and 100d to remotely provide various solutions and content.

The user may check or control information on the robots 100a, 100b, 100c1, 100c2, 100c3, and 100d in the robot system using the PC or the mobile terminal.

In the specification, the ‘user’ may be a person who uses a service through at least one robot, and may include an individual consumer who purchases or rents a robot and uses the robot in a home or elsewhere, managers and employees of a company that provides a service to an employee or a consumer using a robot, and consumers that use a service provided by such a company. Thus, the ‘user’ may include business-to-consumer (B2C) and business-to-business (B2B) cases.

The user may monitor the state and location of the robots 100a, 100b, 100c1, 100c2, 100c3, and 100d in the robot system and may administrate content and task schedules using the PC or the mobile terminal.

The server 10 may store and administrate information received from the robots 100a, 100b, 100c1, 100c2, 100c3, and 100d and other devices.

The server 10 may be a server that is provided by the manufacturer of the robots 100a, 100b, 100c1, 100c2, 100c3, and 100d or a company engaged by the manufacturer to provide services.

The system according to the present invention may be operatively connected to two or more servers.

For example, the server 10 may communicate with external cloud servers 20, such as E1 and E2, and with third parties 30 providing content and services, such as T1, T2, and T3. Accordingly, the server 10 may be operatively connected to the external cloud servers 20 and with third parties 30 and may provide various services.

The server 10 may be a control server for administrating and controlling the robots 100a, 100b, 100c1, 100c2, 100c3, and 100d.

The server 10 may collectively or individually control the robots 100a, 100b, 100c1, 100c2, 100c3, and 100d. In addition, the server 10 may group at least some of the robots 100a, 100b, 100c1, 100c2, 100c3, and 100d and may perform control for each group.

The server 10 may be configured as a plurality of servers, to which information and functions are distributed, or as a single integrated server.

Because the server 10 may be configured as a plurality of servers, to which information and functions are distributed, or as a single integrated server and may administrate the overall service using the robots, the server may be called a robot service delivery platform (RSDP).

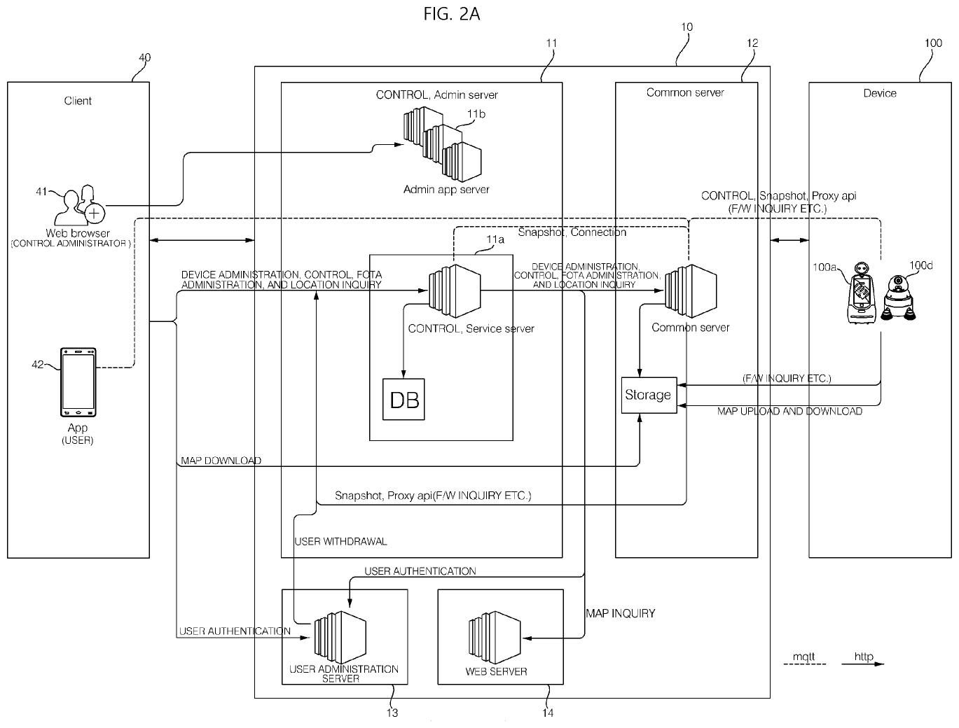

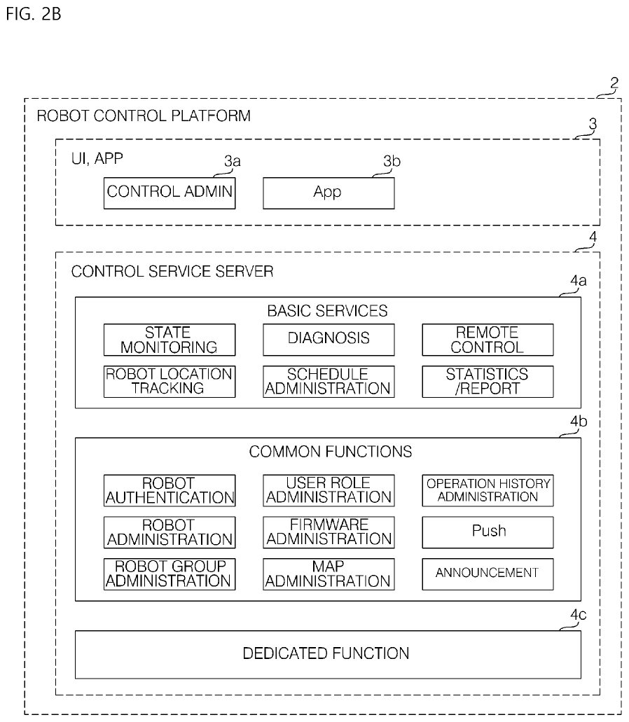

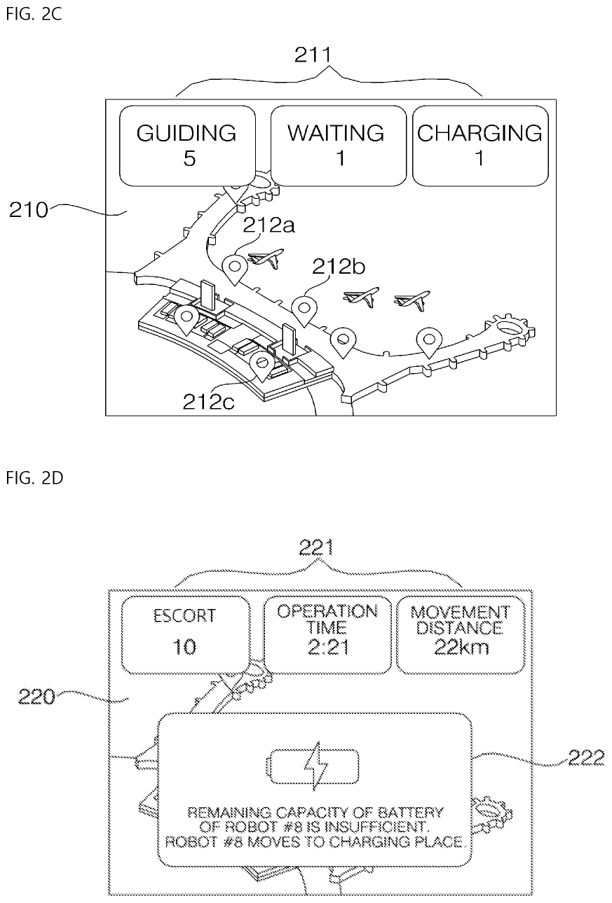

FIGS. 2A to 2D are reference diagrams illustrating a robot service delivery platform included in the robot system according to the embodiment of the present invention.

FIG. 2A exemplarily illustrates a communication architecture of a robot service delivery platform according to an embodiment of the present invention.

Referring to FIG. 2A, the robot service delivery platform 10 may include one or more servers 11 and 12 and may administrate and control robots 100, such as the guide robot 100a or the cleaning robot 100d.

The robot service delivery platform 10 may include a control server 11 that communicates with a client 40 through a web browser 41 or an application 42 in a mobile terminal and administrates and controls the robots 100 and a device administration server 12 for relaying and administrating data related to the robot 100.

The control server 11 may include a control/service server 11a for providing a control service capable of monitoring the state and location of the robots 100 and administrating content and task schedules based on user input received from the client 40 and an administrator application server 11b that a control administrator is capable of accessing through the web browser 41.

The control/service server 11a may include a database, and may respond to a service request from the client 40, such as robot administration, control, firmware over the air (FOTA) upgrade, and location inquiry.

The control administrator may be capable of accessing the administrator application server 11b under the authority of the administrator, and the administrator application server may administrate functions related to the robot, applications, and content.

The device administration server 12 may function as a proxy server, may store metadata related to original data, and may perform a data backup function using a snapshot indicating the state of a storage device.

The device administration server 12 may include a storage for storing various data and a common server that communicates with the control/service server 11a. The common server may store various data in the storage, may retrieve data from the storage, and may respond to a service request from the control/service server 11a, such as robot administration, control, firmware over the air, and location inquiry.

In addition, the robots 100 may download map data and firmware data stored in the storage.

Because the control server 11 and the device administration server 12 are separately configured, it is not necessary to store data in the storage or to retransmit the data, which may be advantageous in terms of the processing speed and time and effective administration may be easily achieved in terms of security.

The robot service delivery platform 10 is a set of servers that provide services related to the robot, and may mean all components excluding the client 40 and the robots 100 in FIG. 2A.

For example, the robot service delivery platform 10 may further include a user administration server 13 for administrating user accounts. The user administration server 13 may administrate user authentication, registration, and withdrawal.

In some embodiments, the robot service delivery platform 10 may further include a map server 14 for providing map data and data based on geographical information.

The map data received by the map server 14 may be stored in the control server 11 and/or the device administration server 12, and the map data in the map server 14 may be downloaded by the robots 100. Alternatively, the map data may be transmitted from the map server 14 to the robots 100 according to a request from the control server 11 and/or the device administration server 12.

The robots 100 and the servers 11 and 12 may include a communication element that support one or more communication protocols and may communicate with each other.

Referring to FIG. 2A, the robots 100 and the servers 11 and 12 may communicate with each other using the MQTT scheme. The MQTT scheme is a scheme in which a message is transmitted and received through a broker, and is advantageous in terms of low power and speed. In the case in which the robot service delivery platform 10 uses the MQTT scheme, the broker may be constructed in the device administration server 12.

In addition, the robots 100 and the servers 11 and 12 may support two or more communication protocols, and may use the optimal communication protocol depending on the type of communication data or the type of a device participating in communication. FIG. 2A exemplarily illustrates a communication path using the MQTT scheme and a communication path using the HTML scheme.

The servers 11 and 12 and the robots 100 may communicate with each other using the MQTT scheme irrespective of the type of the robots.

The robots 100 may transmit the current state thereof to the servers 11 and 12 through an MQTT session, and may receive remote control commands from the servers 11 and 12. For MQTT connection, a digital certificate of authentication, such as a personal key (issued for SCR generation), an X.509 certificate of authentication received at the time of robot registration, a certificate of device administration server authentication, or other authentication schemes may be used.

In FIG. 2A, the servers 11, 12, 13, and 14 are classified based on the functions thereof. However, the present invention is not limited thereto. Two or more functions may be performed by a single server, and a single function may be performed by two or more servers.

FIG. 2B exemplarily illustrates a block diagram of the robot service delivery platform according to the embodiment of the present invention, and exemplarily illustrates upper-level applications of a robot control platform related to robot control.

Referring to FIG. 2B, the robot control platform 2 may include a user interface 3 and functions/services 4 provided by the control/service server 11a.

The robot control platform 2 may provide a web site-based control administrator user interface 3a and an application-based user interface 3b.

The client 40 may use the user interface 3b, provided by the robot control platform 2 through a device used by the client 40 itself.

FIGS. 2C and 2D are diagrams showing an example of a user interface provided by the robot service delivery platform 10 according to the embodiment of the present invention.

FIG. 2C illustrates a monitoring screen 210 related to a plurality of guide robots 100a.

Referring to FIG. 2C, the user interface screen 210 provided by the robot service delivery platform 10 may include state information 211 of the robots and location information 212a, 212b, and 212c of the robots.

The state information 211 may indicate the current state of the robots, such as guiding, waiting, or charging.

The location information 212a, 212b, and 212c may indicate the current location of the robots on a map screen. In some embodiments, the location information 212a, 212b, and 212c may be displayed using different shapes and colors depending on the state of the corresponding robot, and may thus provide a larger amount of information.

The user may monitor the operation mode of the robot and the current location of the robot in real time through the user interface screen 210.

FIG. 2D illustrates monitoring screens related to an individual guide robot 100a.

Referring to FIG. 2D, when the individual guide robot 100a is selected, a user interface screen 220 including history information 221 for a predetermined time period may be provided.

The user interface screen 220 may include current location information of the selected individual guide robot 100a.

The user interface screen 220 may further include notification information 222 about the separate guide robot 100a, such as the remaining capacity of a battery and movement thereof.

Referring to FIG. 2B, the control/service server 11a may include common units 4a and 4b including functions and services that are commonly applied to a plurality of robots and a dedicated unit 4c including specialized functions related to at least some of the plurality of robots.

In some embodiments, the common units 4a and 4b may be classified into basic services 4a and common functions 4b.

The common units 4a and 4b may include a state monitoring service for checking the state of the robots, a diagnostic service for diagnosing the state of the robots, a remote control service for remotely controlling the robots, a robot location tracking service for tracking the location of the robots, a schedule administration service for assigning, checking, and modifying tasks of the robots, a statistics/report service capable of checking various statistical data and analysis reports, and the like.

The common units 4a and 4b may include a user role administration function of administrating the authority of a robot authentication function user, an operation history administration function, a robot administration function, a firmware administration function, a push function related to push notification, a robot group administration function of setting and administrating groups of robots, a map administration function of checking and administrating map data and version information, an announcement administration function, and the like.

The dedicated unit 4c may include specialized functions obtained by considering the places at which the robots are operated, the type of services, and the demands of customers. The dedicated unit 4c may mainly include a specialized function for B2B customers. For example, in the case of the cleaning robot 100d, the dedicated unit 4c may include a cleaning area setting function, a function of monitoring a state for each site, a cleaning reservation setting function, and a cleaning history inquiry function.

The specialized function provided by the dedicated unit 4c may be based on functions and services that are commonly applied. For example, the specialized function may also be configured by modifying the basic services 4a or adding a predetermined service to the basic services 4a. Alternatively, the specialized function may be configured by partially modifying the common function.

In this case, the basic service or the common function corresponding to the specialized function provided by the dedicated unit 4c may be removed or inactivated.

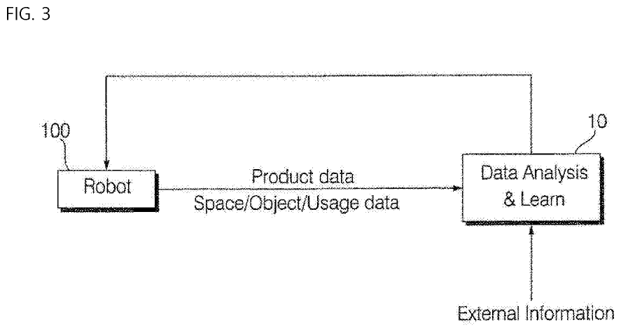

FIG. 3 is a reference view illustrating learning using data acquired by a robot according to an embodiment of the present invention.

Referring to FIG. 3, product data acquired through an operation of a predetermined device, such as a robot 100, may be transmitted to the server 10.

For example, the robot 100 may transmit data related to a space, an object, and usage to the server 10.

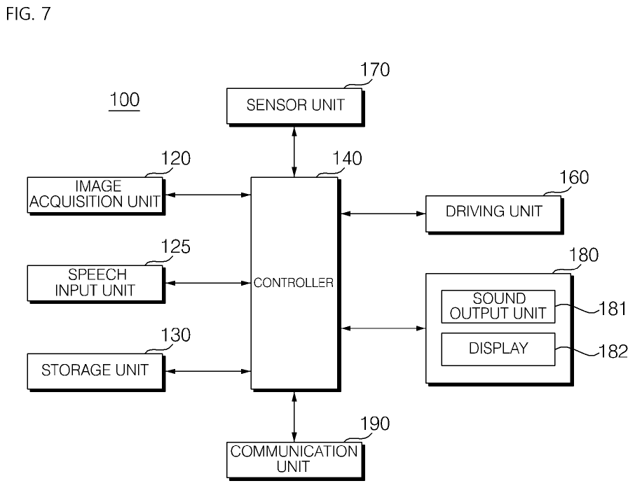

Here, the data related to a space, an object, and usage may be data related to recognition of a space and an object recognized by the robot 100 or may be image data of a space or object acquired by an image acquisition unit 120 (refer to FIG. 7).

In some embodiments, the robot 100 and the server 10 may include a software or hardware type artificial neural network (ANN) trained to recognize at least one of the attributes of a user, the attributes of speech, the attributes of a space, or the attributes of an object, such as an obstacle.

According to an embodiment of the present invention, the robot 100 and the server 10 may include a deep neural network (DNN) trained using deep learning, such as a convolutional neural network (CNN), a recurrent neural network (RNN), or a deep belief network (DBN). For example, the deep neural network (DNN), such as the convolutional neural network (CNN), may be installed in a controller 140 (refer to FIG. 7) of the robot 100.

The server 10 may train the deep neural network (DNN) based on the data received from the robot 100 and data input by a user, and may then transmit the updated data of the deep neural network (DNN) to the robot 100. Accordingly, the deep neural network (DNN) of artificial intelligence included in the robot 100 may be updated.

The usage related data may be data acquired in the course of use of a predetermined product, e.g., the robot 100, may include usage history data and sensing data acquired by a sensor unit 170 (refer to FIG. 7).

The trained deep neural network (DNN) may receive input data for recognition, may recognize the attributes of a person, an object, and a space included in the input data, and may output the result.

The trained deep neural network (DNN) may receive input data for recognition, and may analyze and train usage related data of the robot 100 and may recognize the usage pattern and the usage environment.

The data related to a space, an object, and usage may be transmitted to the server 10 through a communication unit 190 (refer to FIG. 7).

The server 10 may train the deep neural network (DNN) based on the received data, may transmit the updated configuration data of the deep neural network (DNN) to the robot 10, and may then update the data.

Accordingly, a user experience UX in which the robot 100 becomes smarter and evolves along with continual use thereof may be provided.

The robot 100 and the server 10 may also use external information. For example, the server 10 may synthetically use external information acquired from other service servers 20 and associated therewith and may provide an excellent user experience UX.

The server 10 may receive a speech input signal from a user and may perform speech recognition. To this end, the server may include a speech recognition module, and the speech recognition module may include an artificial neural network trained to perform speech recognition on input data and to output the speech recognition result.

In some embodiments, the server 10 may include a speech recognition server for speech recognition. In addition, the speech recognition server may also include a plurality of servers for performing assigned speech recognition procedure. For example, the speech recognition server may include an automatic speech recognition (ASR) server for receiving speech data and converting the received speech data into text data and a natural language processing (NLP) server for receiving the text data from the automatic speech recognition server, analyzing the received text data, and determining a speech command. Depending on the cases, the speech recognition server may further include a text to speech (TTS) server for converting the text speech recognition result output by the natural language processing server into speech data and transmitting the speech data to another server or device.

According to the present invention, because the robot 100 and/or the server 10 are capable of performing speech recognition, user speech may be used as input for controlling the robot 100.

According to the present invention, the robot 100 may actively provide information or output speech for recommending a function or a service first, and thus more various and active control functions may be provided to the user.

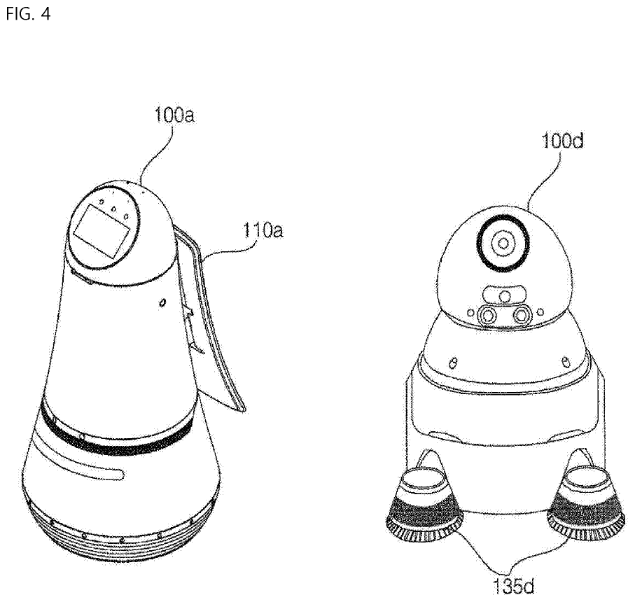

FIGS. 4, 5, and 6A to 6D are diagrams showing examples of robots according to embodiments of the present invention. The robots 100 may be disposed or may travel in specific spaces and may perform assigned tasks.

FIG. 4 illustrates an example of mobile robots that are mainly used in a public place. The mobile robot is a robot that autonomously moves using wheels. Accordingly, the mobile robot may be a guide robot, a cleaning robot, a domestic robot, a guard robot. However, the present invention is not limited at to the type of the mobile robot.

FIG. 4 illustrates an example of a guide robot 100a and a cleaning robot 100d.

The guide robot 100a may include a display 110a and may display a predetermined image, such as a user interface screen.

The guide robot 100a may display a user interface (UI) image including events, advertisements, and guide information on the display 110a. The display 110a may be configured as a touchscreen and may also be used as an input element.

The guide robot 100a may receive user input, such as touch input or speech input, and may display information on an object or a place corresponding to the user input on a screen of the display 110a.

In some embodiments, the guide robot 100a may include a scanner for identifying a ticket, an airline ticket, a barcode, a QR code, and the like for guidance.

The guide robot 100a may provide an escort service of directly guiding a user to a specific destination while moving to the specific destination in response to a user request.

The cleaning robot 100d may include a cleaning tool 135d, such as a brush, and may clean a specific space while autonomously moving.

The mobile robots 100a and 100d may perform assigned tasks while traveling in specific spaces. The mobile robots 100a and 100d may perform autonomous travel, in which the robots move while generating a path to a specific destination, or following travel, in which the robots follow people or other robots. To prevent a safety-related accident, the mobile robots 100a and 100d may travel while detecting and avoiding an obstacle based on image data acquired by the image acquisition unit 120 or sensing data acquired by the sensor unit 170 while moving.

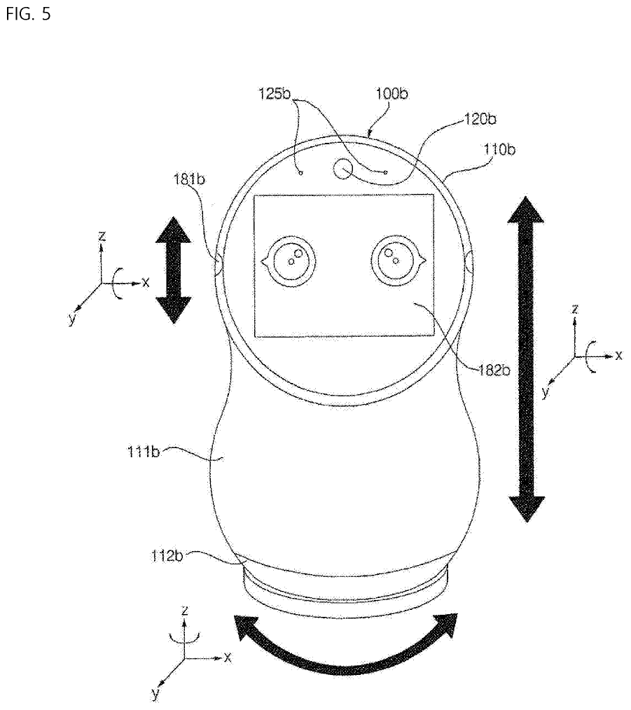

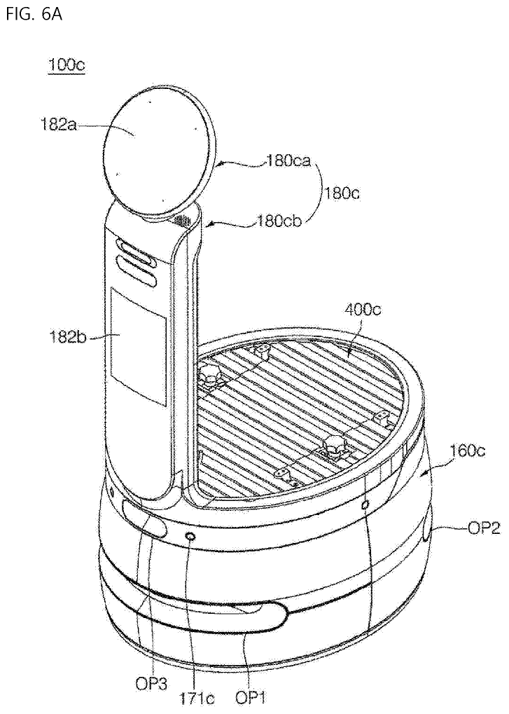

FIG. 5 is a front view illustrating an outer appearance of a home robot according to an embodiment of the present invention.

Referring to FIG. 5, the home robot 100b includes main bodies 111b and 112b for forming an outer appearance thereof and accommodating various components.

The main bodies 111b and 112b may include a body 111b for forming a space for various components included in the home robot 100b, and a support unit 112b disposed at the lower side of the body 111b for supporting the body 111b.

The home robot 100b may include a head 110b disposed at the upper side of the main bodies 111b and 112b. A display 182b for displaying an image may be disposed on a front surface of the head 110b.

In the specification, the forward direction may be a positive y-axis direction, the upward and downward direction may be a z-axis direction, and the leftward and rightward direction may be an x-axis direction.

The head 110b may be rotated about the x axis within a predetermined angular range.

Accordingly, when viewed from the front, the head 110b may nod in the upward and downward direction in the manner in which a human head nods in the upward and downward direction. For example, the head 110b may perform rotation and return within a predetermined range once or more in the manner in which a human head nods in the upward and downward direction.

In some embodiments, at least a portion of the front surface of the head 100b, on which the display 182b corresponding to the face of the human is disposed, may be configured to nod.

Thus, in the specification, although an embodiment in which the entire head 110b is moved in the upward and downward direction is described, unless particularly otherwise, the operation in which the head 110b nods in the upward and downward direction may be replaced by the operation in which at least a portion of the front surface of the head, on which the display 182b is disposed, nods in the upward and downward direction.

The body 111b may be configured to rotate in the leftward and rightward direction. That is, the body 111b may be configured to rotate at 360 degrees about the z axis.

In some embodiments, the body 111b may also be configured to rotate about the x axis within a predetermined angular range, and thus the body may move in the manner of bowing in the upward and downward direction. In this case, as the body 111b rotates in the upward and downward direction, the head 110b may also rotate about the axis about which the body 111b is rotated.

Thus, in the specification, the operation in which the head 110b nods in the upward and downward direction may include both the case in which the head 110b rotates about a predetermined axis in the upward and downward direction when viewed from the front and the case in which, as the body 111b nods in the upward and downward direction, the head 110b connected to the body 111b also rotates and thus nods.

The home robot 100b may include an image acquisition unit 120b for capturing an image of surroundings of the main bodies 111b and 112b, or an image of at least a predetermined range based on the front of the main bodies 111b and 112b.

The image acquisition unit 120b may capture an image of the surroundings of the main bodies 111b and 112b and an external environment and may include a camera module. A plurality of cameras may be installed at respective positions to improve photographing efficiency. In detail, the image acquisition unit 120b may include a front camera provided at the front surface of the head 110b for capturing an image of the front of the main bodies 111b and 112b.

The home robot 100b may include a speech input unit 125b for receiving user speech input.

The speech input unit 125b may include or may be connected to a processing unit for converting analog sound into digital data and may convert a user input speech signal into data to be recognized by the server 10 or the controller 140.

The speech input unit 125b may include a plurality of microphones for improving the accuracy of reception of user speech input and determining the location of a user.

For example, the speech input unit 125b may include at least two microphones.

The plurality of microphones (MIC) may be spaced apart from each other at different positions and may acquire and convert an external audio signal including a speech signal into an electrical signal.

At least two microphones, that is, input devices, may be required to estimate a sound source from which sound is generated and the orientation of the user, and as the physical distance between the microphones increases, resolution (angle) in detecting the direction increases. In some embodiments, two microphones may be disposed on the head 110b. Two microphones may be further disposed on the rear surface of the head 110b, and thus the location of the user in a three-dimensional space may be determined.

Sound output units 181b may be disposed on the left and right surfaces of the head 110b and may output predetermined information in the form of sound.

The outer appearance and configuration of the robot exemplified in FIG. 5 is exemplary and the present invention is not limited thereto. For example, the entire robot 110 may tilt or swing in a specific direction, differently from the rotational direction of the robot 100 exemplified in FIG. 5.

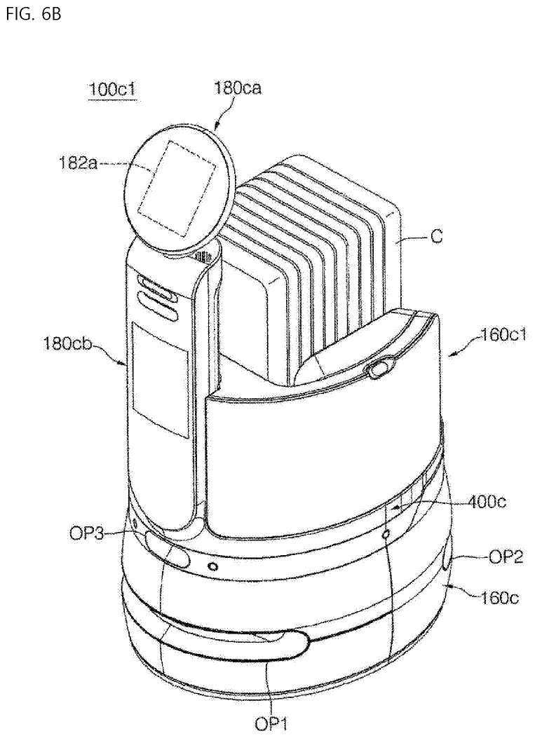

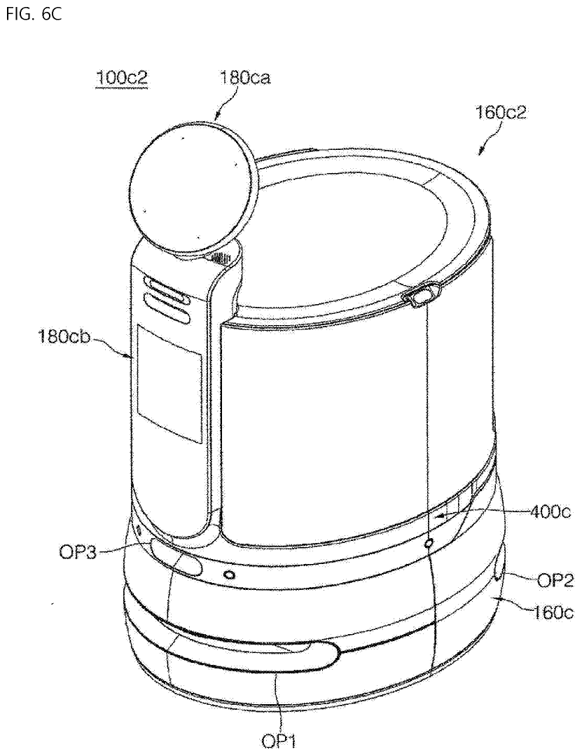

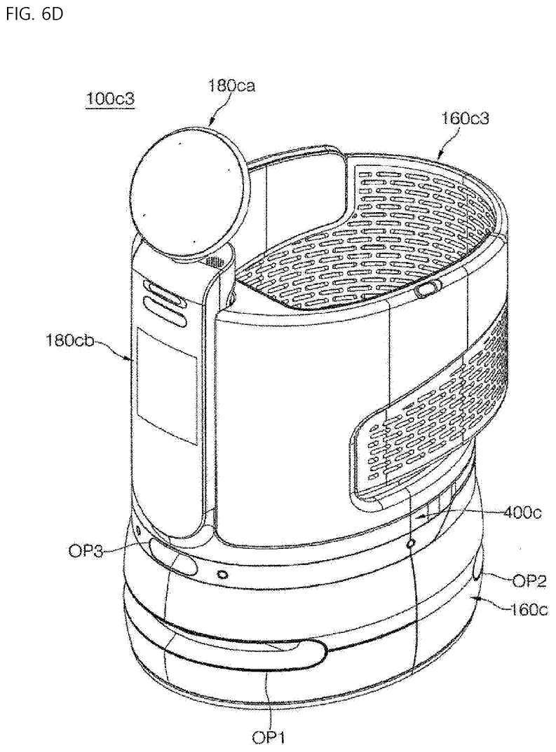

FIGS. 6A to 6D are diagrams showing examples of delivery robots 100c, 100c1, 100c2, and 100c3 for delivering predetermined articles.

Referring to the drawings, the delivery robots 100c, 100c1, 100c2, and 100c3 may travel in an autonomous or following manner, each of the delivery robots may move to a predetermined place while carrying a load, an article, or a carrier C, and depending on the cases, each of the delivery robots may also provide an escort service of guiding a user to a specific place.

The delivery robots 100c, 100c1, 100c2, and 100c3 may travel autonomously at a specific place and may provide guidance to a specific place or may deliver loads, such as baggage.

The delivery robots 100c, 100c1, 100c2, and 100c3 may follow a user while maintaining a predetermined distance from the user.

In some embodiments, each of the delivery robots 100c, 100c1, 100c2, and 100c3 may include a weight sensor for detecting the weight of a load to be delivered, and may inform the user of the weight of the load detected by the weight sensor.

A modular design may be applied to each of the delivery robots 100c, 100c1, 100c2, and 100c3 and may provide services optimized depending on the use environment and purpose.

For example, the basic platform 100c may include a traveling module 160c, which is in charge of traveling and includes a wheel and a motor, and a UI module 180c, which is in charge of interacting with a user and includes a display, a microphone, and a speaker.

Referring to the drawings, the traveling module 160c may include one or more openings OP1, OP2, and OP3.

The first opening OP1 may be formed in the traveling module 160c to allow a front lidar to be operable, and may be formed over the front to the side of the outer circumferential surface of the traveling module 160c.

The front lidar may be disposed in the traveling module 160c to face the first opening OP1. Accordingly, the front lidar may emit a laser through the first opening OP1.

The second opening OP2 may be formed in the traveling module 160c to allow a rear lidar to be operable, and may be formed over the rear to the side of the outer circumferential surface of the traveling module 160c.

The rear lidar may be disposed in the traveling module 160c to face the second opening OP2. Accordingly, the rear lidar may emit a laser through the second opening OP2.

The third opening OP3 may be formed in the traveling module 160c to allow a sensor disposed in the traveling module, such as a cliff sensor for detecting whether a cliff is present on a floor within a traveling area, to be operable.

A sensor may be disposed on the outer surface of the traveling module 160c. An obstacle sensor, such as an ultrasonic sensor 171c, for detecting an obstacle may be disposed on the outer surface of the traveling module 160c.

For example, the ultrasonic sensor 171c may be a sensor for measuring a distance between an obstacle and each of the delivery robots 100c, 100c1, 100c2, and 100c3 using an ultrasonic signal. The ultrasonic sensor 171c may detect an obstacle adjacent to each of the delivery robots 100c, 100c1, 100c2, and 100c3.

For example, a plurality of ultrasonic sensors 171c may be configured to detect obstacles adjacent to the delivery robots 100c, 100c1, 100c2, and 100c3 in all directions. The ultrasonic sensors 171c may be spaced apart from each other along the circumference of the traveling module 160c.

In some embodiments, the UI module 180c may include two displays 182a and 182b, and at least one of the two displays 182a and 182b may be configured in the form of a touchscreen and may also be used as an input element.

The UI module 180c may further include the camera of the image acquisition unit 120. The camera may be disposed on the front surface of the UI module 180c and may acquire image data of a predetermined range from the front of the UI module 180c.

In some embodiments, at least a portion of the UI module 180c may be configured to rotate. For example, the UI module 180c may include a head unit 180ca configured to rotate in the leftward and rightward direction and a body unit 180cb for supporting the head unit 180ca.

The head unit 180ca may rotate based on an operation mode and a current state of the delivery robots 100c, 100c1, 100c2, and 100c3.

The camera may be disposed at the head unit 180ca and may acquire image data of a predetermined range in a direction in which the head unit 180a is oriented.

For example, in the following travel mode in which the delivery robots 100c, 100c1, 100c2, and 100c3 follow a user, the head unit 180ca may rotate to face forwards. In the guide mode in which the delivery robots 100c, 100c1, 100c2, and 100c3 provide an escort service of guiding a user to a predetermined destination while moving ahead of the user, the head unit 180ca may rotate to face backwards.

The head unit 180ca may rotate to face a user identified by the camera.

The porter robot 100c1 may further include a delivery service module 160c1 for accommodating a load as well as components of the basic platform 100c. In some embodiments, the porter robot 100c1 may include a scanner for identifying a ticket, an airline ticket, a barcode, a QR code, and the like for guidance.

The serving robot 100c2 may further include a serving service module 160c2 for accommodating serving articles as well as the components of the basic platform 100c. For example, serving articles in a hotel may correspond to towels, toothbrushes, toothpaste, bathroom supplies, bedclothes, drinks, foods, room service items, or other small electronic devices. The serving service module 160c2 may include a space for accommodating serving articles and may stably deliver the serving articles. The serving service module 160c2 may include a door for opening and closing the space for accommodating the serving articles, and the door may be manually and/or automatically opened and closed.

The cart robot 100c3 may further include a shopping cart service module 160c3 for accommodating customer shopping articles as well as the components of the basic platform 100c. The shopping cart service module 160c3 may include a scanner for recognizing a barcode, a QR code, and the like of a shopping article.

The service modules 160c1, 160c2, and 160c3 may be mechanically coupled to the traveling module 160c and/or the UI module 180c. The service modules 160c1, 160c2, and 160c3 may be conductively coupled to the traveling module 160c and/or the UI module 180 and may transmit and receive a signal. Accordingly, they may be organically operated.

To this end, the delivery robots 100c, 100c1, 100c2, and 100c3 may include a coupling unit 400c for coupling the traveling module 160c and/or the UI module 180 to the service modules 160c1, 160c2, and 160c3.

FIG. 7 is a schematic internal block diagram illustrating an example of a robot according to an embodiment of the present invention.

Referring to FIG. 7, the robot 100 according to the embodiment of the present invention may include a controller 140 for controlling an overall operation of the robot 100, a storage unit 130 for storing various data, and a communication unit 190 for transmitting and receiving data to and from another device such as the server 10.

The controller 140 may control the storage unit 130, the communication unit 190, a driving unit 160, a sensor unit 170, and an output unit 180 in the robot 100, and thus may control an overall operation of the robot 100.

The storage unit 130 may store various types of information required to control the robot 100 and may include a volatile or nonvolatile recording medium. The recording medium may store data readable by a microprocessor and may include, for example, a hard disk drive (HDD), a solid state disk (SSD), a silicon disk drive (SDD), a ROM, a RAM, a CD-ROM, a magnetic tape, a floppy disk, and an optical data storage device.

The controller 140 may control the communication unit 190 to transmit the operation state of the robot 100 or user input to the server 10 or the like.

The communication unit 190 may include at least one communication module, may connect the robot 100 to the Internet or to a predetermined network, and may communicate with another device.

The communication unit 190 may be connected to a communication module provided in the server 10 and may process transmission and reception of data between the robot 100 and the server 10.

The robot 100 according to the embodiment of the present invention may further include a speech input unit 125 for receiving user speech input through a microphone.

The speech input unit 125 may include or may be connected to a processing unit for converting analog sound to digital data and may convert a user input speech signal into data to be recognized by the server 10 or the controller 140.

The storage unit 130 may store data for speech recognition, and the controller 140 may process the user speech input signal received through the speech input unit 125, and may perform a speech recognition process.

The speech recognition process may be performed by the server 10, not by the robot 100. In this case, the controller 140 may control the communication unit 190 to transmit the user speech input signal to the server 10.

Alternatively, simple speech recognition may be performed by the robot 100, and high-dimensional speech recognition such as natural language processing may be performed by the server 10.

For example, upon receiving speech input including a predetermined keyword, the robot 100 may perform an operation corresponding to the keyword, and other speech input may be performed through the server 10. Alternatively, the robot 100 may merely perform wake word recognition for activating a speech recognition mode, and subsequent speech recognition of the user speech input may be performed through the server 10.

The controller 140 may perform control to enable the robot 100 to perform a predetermined operation based on the speech recognition result.

The robot 100 may include an output unit 180 and may display predetermined information in the form of an image or may output the predetermined information in the form of sound.

The output unit 180 may include a display 182 for displaying information corresponding to user command input, a processing result corresponding to the user command input, an operation mode, an operation state, and an error state in the form of an image. In some embodiments, the robot 100 may include a plurality of displays 182.

In some embodiments, at least some of the displays 182 may configure a layered structure along with a touchpad and may configure a touchscreen. In this case, the display 182 configuring the touchscreen may also be used as an input device for allowing a user to input information via touch as well as an output device.

The output unit 180 may further include a sound output unit 181 for outputting an audio signal. The sound output unit 181 may output an alarm sound, a notification message about the operation mode, the operation state, and the error state, information corresponding to user command input, and a processing result corresponding to the user command input in the form of sound under the control of the controller 140. The sound output unit 181 may convert an electrical signal from the controller 140 into an audio signal, and may output the audio signal. To this end, a speaker may be embodied.

In some embodiments, the robot 100 may further include an image acquisition unit 120 for capturing an image of a predetermined range.

The image acquisition unit 120 may capture an image of the periphery of the robot 100, an external environment, and the like, and may include a camera module. A plurality of cameras may be installed at predetermined positions for photographing efficiency.

The image acquisition unit 120 may capture an image for user recognition. The controller 140 may determine an external situation or may recognize a user (a guidance target) based on the image captured by the image acquisition unit 120.

When the robot 100 is a mobile robot such as the guide robot 100a, the delivery robots 100c, 100c1, 100c2, and 100c3, and the cleaning robot 100d, the controller 140 may perform control to enable the robot 100 to travel based on the image captured by the image acquisition unit 120.

The image captured by the image acquisition unit 120 may be stored in the storage unit 130.

When the robot 100 is a mobile robot such as the guide robot 100a, the delivery robots 100c, 100c1, 100c2, and 100c3, and the cleaning robot 100d, the robot 100 may further include a driving unit 160 for movement. The driving unit 160 may move a main body under the control of the controller 140.

The driving unit 160 may include at least one driving wheel for moving the main body of the robot 100. The driving unit 160 may include a driving motor connected to the driving wheel for rotating the driving wheel. Respective driving wheels may be installed on left and right sides of the main body and may be referred to as a left wheel and a right wheel.

The left wheel and the right wheel may be driven by a single driving motor, but as necessary, a left wheel driving motor for driving the left wheel and the right wheel driving motor for driving the right wheel may be separately installed. A direction in which the main body travels may be changed to the left or to the right based on a rotational speed difference between the left wheel and the right wheel.

An immobile robot 100 such as the home robot 100b may include a driving unit 160 for performing a predetermined action as described above with reference to FIG. 5.

In this case, the driving unit 160 may include a plurality of driving motors for rotating and/or moving the body 111b and the head 110b.

The robot 100 may include a sensor unit 170 including sensors for detecting various data related to an operation and state of the robot 100.

The sensor unit 170 may further include an operation sensor for detecting an operation of the robot 100 and outputting operation information. For example, a gyro sensor, a wheel sensor, or an acceleration sensor may be used as the operation sensor.

The sensor unit 170 may include an obstacle sensor for detecting an obstacle. The obstacle sensor may include an infrared sensor, an ultrasonic sensor, an RF sensor, a geomagnetic sensor, a position sensitive device (PSD) sensor, a cliff sensor for sensing whether a cliff is present on a floor within a traveling area, and a light detection and ranging (lidar).

The obstacle sensor senses an object, particularly an obstacle, present in the direction in which the mobile robot 100 travels (moves), and transfers information on the obstacle to the controller 140. In this case, the controller 140 may control the motion of the robot 100 depending on the position of the detected obstacle.

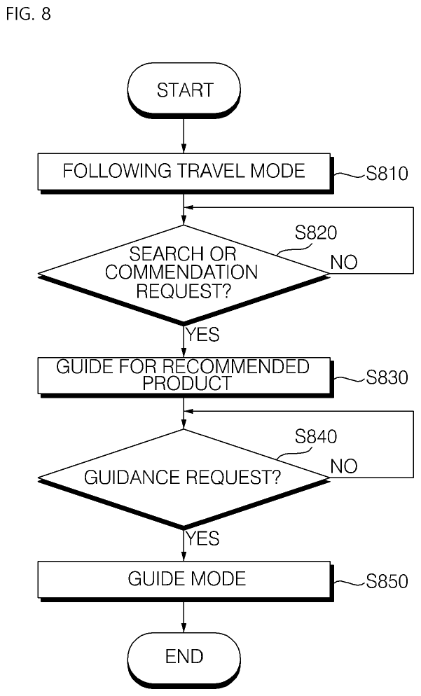

FIG. 8 is a flowchart illustrating a method of controlling a robot according to an embodiment of the present invention.

Referring to FIG. 8, the robot 100 according to an embodiment of the present invention may be operated in a following travel mode in which the robot follows a user (S810).

The robot 100 according to an embodiment of the present invention may be operated in a following travel mode in which the robot 100 travels and follows the user.

In the present embodiment, the robot 100 may be the delivery robots 100c1, 100c2, and 100c3 that move while carrying an article of a user. The delivery robots 100c1, 100c2, and 100c3 may carry the article of the user and may follow the user in the following travel mode.

In more detail, in the present embodiment, the robot 100 may be the cart robot 100c3. The cart robot 100c3 may travel in an autonomous or following manner and may be operated in a following travel mode in which the robot follows and travels based on a predetermined user, and alternatively in a guidance mode in which the robot performs an escort service for providing guidance for a predetermined destination while moving ahead of the user while traveling autonomously.

The cart robot 100c3 may carry a shopping article of a customer. The cart robot 100c3 may include a scanner for identifying product information such as a barcode and may provide an additional service related to shopping, such as checking product information or payment while carrying the shopping article.

The robot 100 may receive user input including a product inquiry or recommendation service request (S820).

The product inquiry service request may be a request for inquiry of a predetermined product, in which case a user makes a request for inquiry of a predetermined product using various elements. For example, the user may input a search keyword for a predetermined product, such as a product name or a category title, in the form of touch or speech, and the robot 100 may search for the input keyword such as a product name or a category title from a pre-stored database or a database connected to a network.

The recommendation service request may be a request for a recommendation of a predetermined product, in which case a user makes a request for a recommendation of a product via speech input or touch input on the display 182.

When the recommendation service request is made to a user who performs an interaction for a specific product or an event, the robot 100 may identify predetermined data or may communicate with the server 10 to identify a specific product or an event as a recommended product or event.

According to an embodiment of the present invention, upon receiving user input including the product inquiry or the recommendation service request (S820), the robot 100 may output a guidance message for providing guidance for a recommended product in the form of an image and/or speech in response to the user input (S830).

There, the guided recommended product may be at least one product that is selected among the search result, the determined recommended product, or an event, and if necessary, a plurality of recommended products may be proposed.

As described above, the robot 100 may be the cart robot 100c3. In this case, the cart robot 100c3 may scan a bar code of a predetermined product using a scanner included therein, and may output the scan result including article information of the predetermined product in the form of an image and/or speech.

A bar code may represent a word, a number, or the like in a pattern configured in black and white, may be disposed on a wrapper of a product or a tag, and may simplify product information input, and payment. Accordingly, if necessary, the QR code may be a two-dimensional barcode and may be included in the definition of a bar code in the specification.

In the specification, although an example of product identification and data processing using barcode scanning is described, another type of product identification or a data processing method may also be applied.

According to an embodiment of the present invention, the cart robot 100c3 may include a scanner and may scan a barcode of a predetermined product. The scan result may be uttered via speech through the sound output unit 181. A scan result image may be displayed on a first display 181a and/or a second display 181b included in the cart robot 100c3.

The cart robot 100c3 may identify the recommended product based on at least one or more articles that are scanned on that day. Here, the recommended product may be a product related to the one or more articles that are scanned on that day.

The cart robot 100c3 may store product information that is scanned by a current user that is using a service, and when there is a product recommendation request of the user, a product related to at least one scanned products may be recommended.

The product related to the scanned product may be a product with a high probability of being used along with the scanned product, a product that is discounted or is being promoted because the product is of the same type as the related product, supplies required for an operation of the scanned product, a component, or an accessory.

For example, the cart robot 100c3 may recommend other ingredients for a corresponding food or recipe to a user who scans one of the ingredients for the specific food or recipe.

The cart robot 100c3 may recommend another product of a manufacturer of the scanned product or a product similar to the scanned product. The similar product may be selected among products belonging to the same category as the scanned product, and when beer is scanned, soju, which falls in the category of liquor, may be recommended, or another type of beer may be recommended.

According to an embodiment of the present invention, the robot 100 may identify a user.

For example, the cart robot 100c3 may include a scanner for identifying a barcode or the like, and may recognize a user by recognizing a barcode or a QR code included in a card proposed by the user or an image of an electronic device and comparing the recognized information with a pre-stored customer database.

The cart robot 100c3 may acquire an image of the face of a user positioned at a front side through the image acquisition unit 120 and may compare the acquired user face image data with a pre-stored customer database to recognize the user.

When the cart robot 100c3 does not include a customer database due to a reason such as a security policy, a data usage amount restriction, or a system resource limit, the cart robot 100c3 may recognize a barcode and a QR code, may transmit the recognized identification information to the server 10, and may receive the checked user information from the server 10.

The server 10 may also transmit a previous purchase history or preferred product information of the identified user to the robot 100.

In this case, the robot 100 may identify the recommended product based on the previous purchase history or preferred product information of the user, received from the server 10.

The server 10 may identify the recommended product based on the previous purchase history or preferred product information of the user and may transfer information on the identified recommended product to the robot 100.

According to an embodiment of the present invention, the robot 100 may output a guidance message for providing guidance for the recommended product in the form of an image and/or speech in response to the user input (S830), and the user may view or disregard a guidance message for providing guidance for the recommended product, may directly move, or may make a request for an escort service.

Upon receiving user input for a request for an escort service in which a robot performs guidance while moving to a place corresponding to the recommended product (S840), the robot 100 may switch to a guide mode in which the robot performs guidance while moving ahead of the user to the place corresponding to the recommended product (S850).

According to the present invention, the robot 100 may determine the case in which guidance for a specific product is necessary through an interaction with the user and may switch to an active guide mode from a passive following travel mode.

When the user searches for a product or makes a request for a recommendation, recommended product information may be provided and use of an escort serviced may also be actively induced.

For example, upon detecting specific movement of the user, for example, when the user looks around or merely stays in the same place for a predetermined time, the robot 100 may induce search, recommendation, and an escort service, for example, “What product are you looking for?” to the user.

Thus, aversion to use of the service provided by the robot may be reduced, and use of the service may also spread to people who are not familiar with or do not use the service by the robot.

In some embodiments, the switching to the guide mode may include uttering a speech message for guidance for switching to the guide mode. That is, the robot 100 that follows the user may output one or more speech messages indicating that the robot 100 is operated in a guide mode in which the robot actively guides the user through, for example, “I'm switching to guide mode”, “I will guide you to X”, or “Please follow me” and may start guidance. Accordingly, the user may recognize the mode switch of the robot 100.

The switching to the guide mode may include moving to a predetermined position adjacent to the user based on an expected path to a place corresponding to the recommended product, and uttering a speech message for guidance for switching to the guide mode.

For example, the robot 100 may move to a specific position selected based on an expected path among positions within a predetermined range from the user, may output one or more speech messages indicating that the robot 100 is operated in the guide mode in which the robot that follows the user actively guides the user, and may then start guidance. Accordingly, the user may recognize the mode switch of the robot 100 and may smoothly follow the robot 100.

The robot 100 that is currently operated in the guide mode may monitor movement of the user based on sensing data detected by the sensor unit 170 and/or the user image data acquired through a camera.

For example, a user who currently uses a service may be tracked using a sensor such as a rear lidar or an ultrasonic sensor of the sensor unit 170, and movement of the user may be monitored.

Alternatively, movement of the user may be monitored based on the user image data acquired through the image acquisition unit 120.

For example, the user who currently uses a service may be tracked and movement of the user may be monitored using a camera included in the UI module 180c.

In this case, at least a portion of the UI module 180c included in the camera may be rotated. For example, the head unit 180a of the UI module 180c may be rotated to be oriented toward the user who follows the UI module 180c.

Movement of the user may be monitored by synthetically using data acquired through the sensor unit 170 and the image acquisition unit 120.

Upon detecting specific movement of the user, the robot 100 may switch to the following travel mode in which the robot follows the user. Here, the specific movement may be path departure of the user or rapid change of a user activity.

The case in which the user who follows the robot 100 in the guide mode moves off a travel path may be the case in which guidance is not necessary any longer, for example, the case in which the user is interested in another product on the travel path or stops shopping, or in which another urgent situations arises. Thus, the robot 100 may be operated in the following travel mode in which the robot follows the user who moves off the travel path.

When the user rapidly changes an operation, for example, when a following user rapidly stops, or when a stationary user suddenly moves, there is any reason for the rapid change of the user activity, and thus guidance may be first terminated.

Accordingly, the robot 100 may switch to the following travel mode in which the robot follows the user who changes their operation.

The robot 100 may utter a speech message for providing guidance for switching to the following travel mode through the sound output unit 181.

The robot 100 may utter a speech message for asking to switch back to the guide mode through the sound output unit 181, and thus a user who intends to check another product for a while or intends to use an escort service may ask to switch back to the guide mode, and thus may easily select switching to the guide mode.

When the robot 100 arrives at a place corresponding to the recommended product or there is predetermined user input, an operation in the guide mode may be terminated.

When the cart robot 100c3 arrives at a place corresponding to the recommended product, the guide mode may be terminated and may switch to the following travel mode.

When the recommended product is scanned, the cart robot 100c3 may recognize that guidance is successfully performed, and thus the guide mode may be terminated.

Alternatively, when the recommended product is not scanned for a predetermined time after the cart robot 100c3 arrives at the place corresponding to the recommended product, the guidance speech message may be uttered and then the guide mode may be terminated.

A user who is guided to a specific product or a specific display shelf may freely determine purchase using an escort service. Accordingly, to support shopping of another product of a user who does not want to make a purchase after checking the recommended product, when the recommended product is not scanned for a predetermined time after the cart robot 100c3 arrives at the place corresponding to the recommended product, the guidance speech message may be uttered and then the guide mode may be terminated.

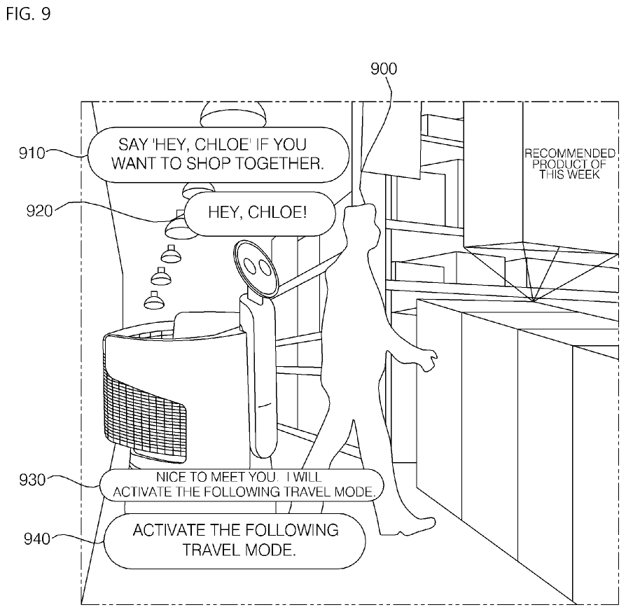

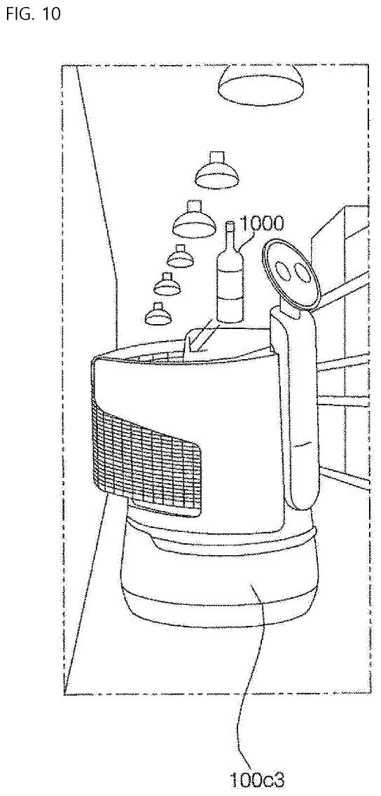

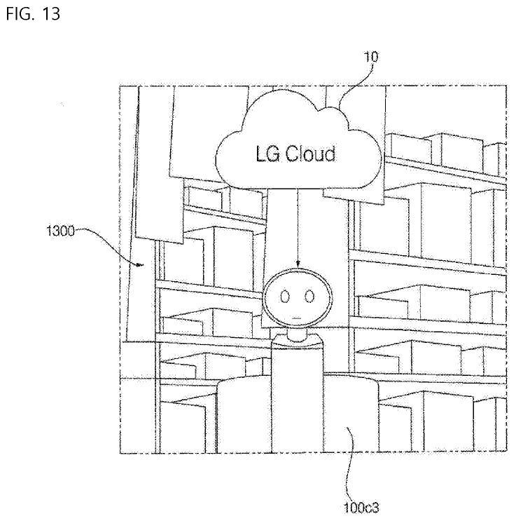

FIGS. 9 to 14 are reference diagrams for explanation of a service provided at a big-box store by a robot according to an embodiment of the present invention.

The robot 100 such as the cart robot 100c3 may induce service use while traveling autonomously in a service place such as a big-box store. For example, when a customer makes a request to the cart robot 100c3 for a service via speech recognition or touching a display or makes a request for activation of the following travel mode, the cart robot 100c3 may support shopping while following the customer in the following travel mode.

Referring to FIG. 9, the cart robot 100c3 that travels autonomously may output a speech guidance message 910 for providing guidance for a method of using a service or a calling expression such as “Say ‘Hey, Chloe’ if you want shopping together.” through the sound output unit 181.

When a customer 900 utters speech including the calling expression (920), the cart robot 100c3 may stop and may output speech guidance messages 930 and 940 such as “Nice to meet you. I will activate the following travel mode.” or “Enjoy shopping while I follow you.”.

The customer 900 may put a product in the service module 160c3 of the cart robot 100c3 that follows the customer in the following travel mode and may easily enjoy shopping while using a carry service of the cart robot 100c3.

The customer 900 may scan a product using a scanner included in the cart robot 100c3 and may enjoy shopping while putting the product in the service module 160c3 of the cart robot 100c3.

Referring to FIG. 10, the customer 900 may scan wine 1000 using a scanner and may put the product in the service module 160c3 of the cart robot 100c3.

The cart robot 100c3 may output the result of scanning the wine 1000.

For example, product information such as the name or price of the scanned product may be displayed on a first display 182a and/or a second display 182b.

Alternatively, a list and prices of products that are scanned on that day may be updated and displayed on the first display 182a and/or the second display 182b.

The UI module 180c of the cart robot 100c3 may output an image on which the price is counted according to the scan result.

When there is service input corresponding to shopping completion or the cart robot 100c3 arrives at a checkout counter such as an autonomous checkout counter, the cart robot 100c3 may assist payment of the customer. According to an embodiment of the present invention, the cart robot 100c3 may provide a simple payment service along with user input or arrival at the checkout counter.

Accordingly, the customer 900 may enjoy their shopping using the cart robot 100c3 without intervention or impedance of another person and may easily carry and pay for a product.

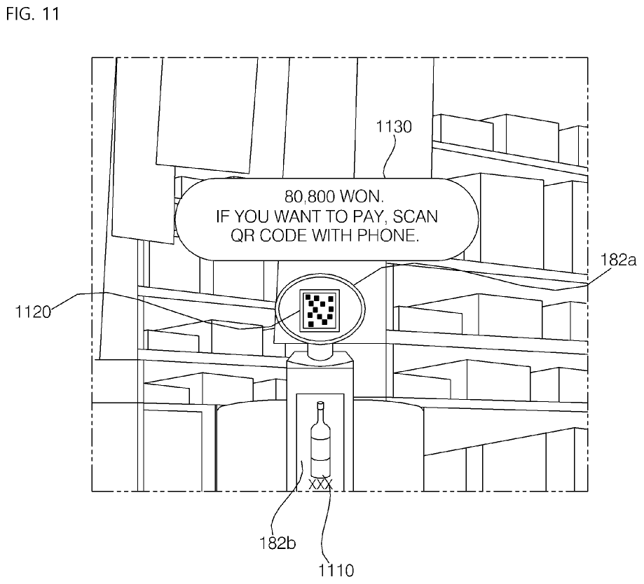

Referring to FIG. 11, the cart robot 100c3 may output a guidance message 1110 indicating payment in the form of an image and/or speech, a payment image 1120 may be activated in the first display 182a of the UI module 180c, and then, the sound output unit 181 may output a speech guidance message 1130 for providing guidance for payment.

In some embodiments, product information on one or more products to be paid for may be displayed on the second display 182b of the UI module 180c.

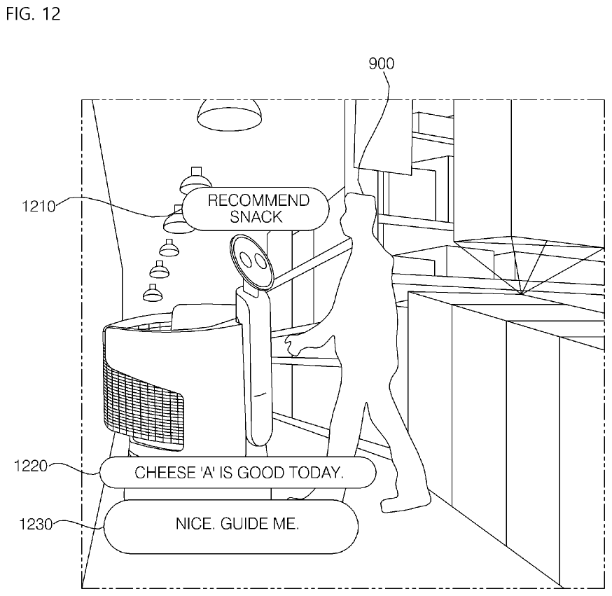

Referring to FIG. 12, the customer 900 may make a request to the cart robot 100c3 that follows the customer 900 in the following travel mode for a recommendation of a predetermined product (1210).

In this case, the cart robot 100c3 may output a guidance message 1220 for providing guidance for a recommended product in response to user input including a product recommendation service request, and upon receiving user input 1230 including an escort service request, the cart robot 100c3 may switch to the guide mode.

According to an embodiment of the present invention, the cart robot 100c3 may download information on a displayed position of a product, an event, or promotion in a big-box store 1300 from the server 10. The cart robot 100c3 may recommend a product according to the event or the promotion based on the information downloaded from the server 10.

If necessary, the cart robot 100c3 may communicate with the server 10 and may receive information on a product or an event that is searched or requested to be recommended by the customer 900.

In some embodiments, when a specific product is scanned, the cart robot 100c3 may recommend a related product of the scanned specific product without a particular request of the customer 900. For example, the cart robot 100c3 may recommend a product being promoted among the same type of products as the scanned specific product, or a product to be used along with the scanned specific product.

While scanning the specific product, the cart robot 100c3 may provide a user interface for searching for another product or recommending another product. When the customer 900 opts to search for or receive recommendations for other products through the provided user interface, the cart robot 100c3 may provide to the retrieved or recommended product (1220).

When the user input 1230 including an escort service request such as a positive answer in response to the recommended product guidance 1220 is received, the current mode may switch to the guide mode.

The customer 900 may make a request anytime to the cart robot 100c3 that follows the customer 900 in the following travel mode for guidance for a predetermined product or a place.

For example, the customer 900 may make a request to the cart robot 100c3 that follows the customer 900 in the following travel mode for an escort service to a place at which products of a specific product group such as cheese are displayed, in the form of speech.

The cart robot 100c3 that receives the request for guidance to the display shelf on which cheese products are displayed may utter a speech guidance message for providing guidance to the display shelf of the corresponding item according to the request of the customer 900.

The cart robot 100c3 may display a rough map indicating a position of the corresponding item on the first display 182a or the like.

When the guide mode begins, the cart robot 100c3 may move to a predetermined position adjacent to the user based on an expected path to a place corresponding to the recommended product and may utter a speech message for guidance for switching to the guide mode.

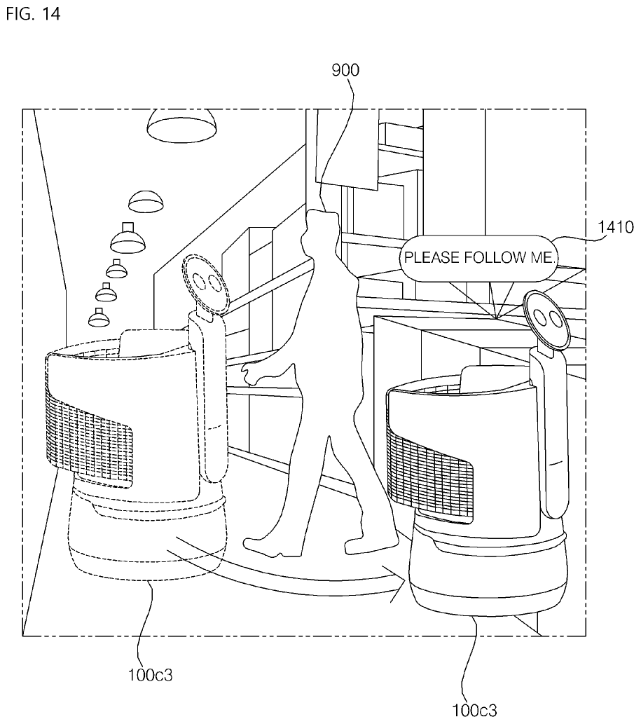

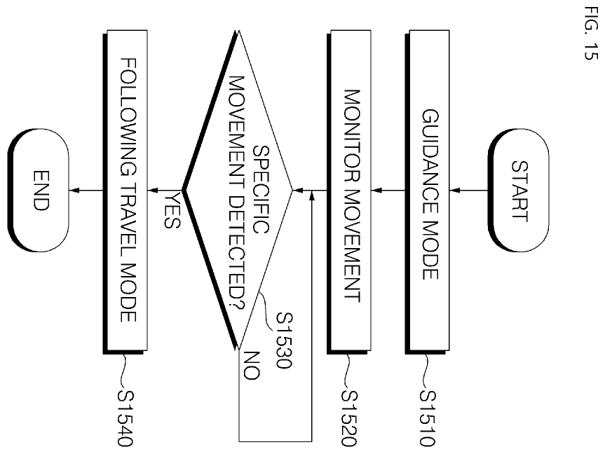

Referring to FIG. 14, the cart robot 100c3 may move to the specific position selected in consideration of the expected path within a predetermined range based on the customer 900. For example, the cart robot 100c3 may move to a front side of the customer 900 based on the expected path and direction.

The cart robot 100c3 may output one or more speech messages 1410 indicating that the robot 100 is operated in the guide mode in which the robot that follows the user actively guides the user and may start guidance. Accordingly, the user may recognize the mode switching of the robot 100 and may smoothly follow the cart robot 100c3.

FIG. 15 is a flowchart illustrating a method of controlling a robot according to an embodiment of the present invention.

Referring to FIG. 15, the robot 100 according to an embodiment of the present invention may be operated in a guide mode in which the robot performs guidance while moving ahead of the user (S1510).

The robot 100 according to an embodiment of the present invention may be operated in a following travel mode in which the robot moves while following the user.

In the present embodiment, the robot 100 may be the delivery robots 100c1, 100c2, and 100c3 that move while carrying articles of the user.

In more detail, in the present embodiment, the robot 100 may be the cart robot 100c3. The cart robot 100c3 may travel in an autonomous or following manner and may be operated in a following travel mode in which the robot follows and travels based on a predetermined user and in a guidance mode in which the robot performs an escort service for providing guidance for a predetermined destination while moving ahead of the user while traveling autonomously.

The cart robot 100c3 may carry a shopping article of a customer. The cart robot 100c3 may include a scanner for identifying product information such as a barcode and may provide an additional service related to shopping, such as checking product information or processing payment while carrying the shopping article.

The robot 100 that is currently operated in the guide mode may monitor movement of the user while traveling in the guide mode (S1520).

The robot 100 may monitor movement of the user based on sensing data detected by the sensor unit 170 and/or the user image data acquired through a camera (S1520).

For example, a user who currently uses a service may be tracked using a sensor such as a rear lidar or an ultrasonic sensor of the sensor unit 170, and movement of the user may be monitored.

Alternatively, movement of the user may be monitored based on the user image data acquired through the image acquisition unit 120.

For example, the user who currently uses a service may be tracked and movement of the user may be monitored using a camera included in the UI module 180c.

In this case, at least a portion of the UI module 180c included in the camera may be rotated. For example, the head unit 180a of the UI module 180c may be rotated to be oriented toward the user who follows the robot.

Movement of the user may be monitored by synthetically using data acquired through the sensor unit 170 and the image acquisition unit 120.

Upon detecting specific movement of the user (S1530), the robot 100 may switch to the following travel mode in which the robot follows the user (S1540). Here, the specific movement may be path departure of the user or rapid change in a user activity.

The case in which the user who follows the robot 100 in the guide mode moves off a travel path may be the case in which guidance is not necessary any longer, for example, the case in which the user is interested in another product on the travel path or stops shopping, or other urgent situations occur. Thus, the robot 100 may be operated in the following travel mode in which the robot follows the user who moves off the travel path.

When the user rapidly changes an operation, for example, when a following user rapidly stops, or when a stationary user suddenly moves, there is any reason for the rapid change of the user activity, and thus guidance may be first terminated.

Accordingly, the robot 100 may switch to the following travel mode in which the robot follows the user who changes their operation.

The robot 100 may utter a speech message for providing guidance for switching to the following travel mode through the sound output unit 181.

The robot 100 may utter a speech message for asking to switch back to the guide mode through the sound output unit 181, and thus a user who intends to check another product for a while or intends to use an escort service may ask to switch back to the guide mode, and thus may easily select switching back to the guide mode.

The robot 100 may track the user and may follow the user through at least one element of a front lidar, an ultrasonic sensor, or a camera.

In some embodiment, along with switching to the following travel mode (S1540), at least a portion of the UI module 180c including a camera may be rotated. For example, the head unit 180a of the UI module 180c may be rotated to be oriented toward the user moves ahead of the head unit 180a.

The customer 900 may make a request to the robot 100 such as the cart robot 100c3 that moves ahead of the customer 900 in the guide mode for switching to the following travel mode.

Accordingly, upon receiving touch or speech input for making a request for switching to the following travel mode during an operation in the guide mode, the robot 100 such as the cart robot 100c3 may switch to the following travel mode.

The robot, the robot system including the robot, and the method of controlling the robot system according to the present invention are not limitedly applied to the constructions and methods of the embodiments as previously described; rather, all or some of the embodiments may be selectively combined to achieve various modifications.

The robot, the robot system including the robot, and the method of controlling the robot system according to the embodiment of the present invention may be implemented as code that can be written on a processor-readable recording medium and thus read by a processor. The processor-readable recording medium may be any type of recording device in which data is stored in a processor-readable manner. The processor-readable recording medium may include, for example, read only memory (ROM), random access memory (RAM), compact disc read only memory (CD-ROM), magnetic tape, a floppy disk, and an optical data storage device, and may be implemented in the form of a carrier wave transmitted over the Internet. In addition, the processor-readable recording medium may be distributed over a plurality of computer systems connected to a network such that processor-readable code is written thereto and executed therefrom in a decentralized manner.

It will be apparent that, although the preferred embodiments have been shown and described above, the present invention is not limited to the above-described specific embodiments, and various modifications and variations can be made by those skilled in the art without departing from the gist of the appended claims. Thus, it is intended that the modifications and variations should not be understood independently of the technical spirit or prospect of the present invention.

What is claimed:

1. A method of controlling a robot, the method comprising:
initially operating the robot, by a controller of the robot, in a following travel mode to follow behind or at a side of a user;
switching the robot from the following traveling mode to a guide mode, by the controller, in response to a received detection signal and escorting the user to a predetermined destination; and
switching the robot from the guide mode to the following travel mode, by the controller, upon detecting a specific movement of the user during the guide mode.

2. The method of claim 1, wherein the received detection signal is a signal corresponding to a request for an escort service from the user.

3. The method of claim 2, wherein the switching to the guide mode from the following travel mode includes:
receiving a user input including a product search request or a product recommendation request;
outputting a guidance message for providing guidance for a recommended product in response to the user input;
receiving the request for the escort service for guiding the user to a place corresponding to the recommended product; and
guiding the user to the place corresponding to the recommended product while moving the robot ahead of the user.

4. The method of claim 3, wherein the switching to the guide mode from the following travel mode further includes:
scanning a bar code of an article; and
outputting a scan result including product information of the scanned article.

5. The method of claim 4, wherein the switching to the guide mode from the following travel mode further includes identifying the recommended product based on one or more articles scanned during a predetermined period of time.

6. The method of claim 5, wherein the recommended product is a product related to the one or more articles scanned during the predetermined period of time.

7. The method of claim 3, wherein the switching to the guide mode from the following travel mode further includes:
identifying the user;
receiving a previous purchase history or a preferred product information of the user from a server; and
identifying the recommended product based on the received previous purchase history or the preferred product information of the user.

8. The method of claim 3, wherein the switching to the guide mode from the following travel mode further includes:
moving the robot to a predetermined position adjacent to the user based on an expected path to the place corresponding to the recommended product; and
uttering, by the robot, a speech message for providing guidance for switching to the guide mode.

9. The method of claim 3, further comprising terminating the guide mode upon the robot arriving at the place corresponding to the recommended product or scanning of the recommended product.

10. The method of claim 3, further comprising terminating the guide mode after a guidance speech message is uttered by the robot when the recommended product is not scanned during a predetermined time after the robot arrives at the place corresponding to the recommended product.

11. The method of claim 2, wherein the switching to the guide mode from the following travel mode includes:
receiving a user input including an event search request or an event recommendation request;
outputting a guidance message for providing guidance for a recommended event in response to the user input;
receiving the request for the escort service for guiding the user to a place corresponding to the recommended event; and
guiding the user to the place corresponding to the recommended event while moving the robot ahead of the user.

12. The method of claim 1, further comprising monitoring movement of the user and detecting the specific movement of the user based on sensing data detected by a sensor module of the robot or user image data acquired through a camera of the robot.

13. The method of claim 1, wherein switching to the guide mode further includes rotating a user interface module including a camera to face the user.

14. The method of claim 1, wherein the specific movement of the user is a path departure by the user during escorting the user to the predetermined destination or a rapid change in an activity of the user.

15. The method of claim 1, further comprising uttering, by the robot, a speech message asking whether to switch back to the following travel mode during the guide mode or to switch back to the guide mode during the following travel mode.

16. A robot, comprising:
a main body;
a service module configured to provide a preset service to a user, the service module being located at the main body;
a user interface configured to receive input from the user and to provide information, the user interface being located at the main body;
a driver configured to move the main body; and
a controller configured to:
operate the driver such that the robot follows the user during a following travel mode;
operate the driver such that the robot escorts the user to a predetermined destination during a guide mode;
switch from the following travel mode to the guide mode in response to a received detection signal; and
switch from the guide mode to the following travel mode upon detecting a specific movement of the user during the guide mode.

17. The robot of claim 16, wherein the user interface is configured to receive a signal corresponding to a request for the escort service from the user as the received detection signal.

18. The robot of claim 17, wherein the user interface is rotatable, and
wherein the controller is configured to rotate the user interface to face the user when switching to the guide mode.

19. The robot of claim 17, further comprising:
a sensor module including at least one sensor configured to detect a surrounding environment movement and movement of the user; and
a camera configured to acquire user image data,
wherein the controller is configured to detect the specific movement of the user based on sensing data detected by the sensor module or the user image data acquired by the camera.

20. The robot of claim 17, wherein the controller is configured to, while operating in the guide mode, switch to the following travel mode upon receiving a touch input or a speech input by the user interface for making a request for switching to the following travel mode.
